(19) United States
(12) Patent Application Publication
(10) Pub. No.: US 2023/0121663 A1
(43) Pub. Date: Apr. 20, 2023

(54) Administrator Proxy Contract for A Decentralized Blockchain

(71) Applicant: Dan Lu, Harrisburg, NC (US)

(72) Inventor: Dan Lu, Harrisburg, NC (US)

(21) Appl. No.: 17/503,384

(22) Filed: Oct. 18, 2021

(51) Int. Cl. H04L 9/32; H04L 9/30

(52) U.S. Cl. CPC H04L 9/3239; H04L 9/3073; H04L 2209/38

(57) ABSTRACT

For a distributed and decentralized blockchain system using state function driven consensus protocol, the identity of the network node that is selected for building the next block is publicly known since it is determined by the blockchain state function at the current blockchain state. An administrator proxy contract protocol is proposed and implemented to protect the identity of the actual builder of the next block until the block is built and synchronized across the blockchain network. A notion of blockchain clock and a method to construct such a clock are introduced to replace computer system clock as a synchronized measure of blockchain state progression. A secured form of the blockchain state function is constructed based on the administrator proxy contract protocol and is used to against any blockchain state manipulation attempts by an adversary.

### CROSS-REFERENCE TO RELATED APPLICATIONS

This application is a continuation of the U.S. patent application Ser. No. 17/140,095, filed on Jan. 3, 2021, which is incorporated by reference herein in its entirety.

### BACKGROUND OF THE INVENTION

The state function driven consensus protocol is used to synchronize block data for a distributed and decentralized blockchain system. The consensus protocol results in a truly decentralized and democratic way in which each of the participating network nodes has equal rights and opportunities in contributing to the building of the blocks to the blockchain. The consensus protocol does not require super computing power from the participating network nodes in order to generate proof-of-work (PoW) to achieve consensus. The consensus process is auditable and verifiable at any point of time by any of the participating network nodes.

A blockchain state is determined by its content, a collection of transactions, a chain of logical groupings of the transactions (blocks), and a collection of the network nodes upon which the blockchain is maintained. A blockchain state function is a unique and surjective mapping between a set of values and a set of blockchain states.

A state function driven consensus protocol is to define a blockchain state function that maps each of the blockchain states in the whole state space to each of the participating network nodes id at any given point of time. The blockchain state function is pre-built in the blockchain system with global adjustable parameters. The protocol is executed on the local copy of the blockchain at each network node upon a change in the blockchain state. When the output of the executed protocol matches the network node id where the local copy of the blockchain is maintained, the network node will build the next block and broadcast the block to other network nodes to achieve consensus. In the case of the selected network node being off line or fault, the protocol automatically ensures selection of the next network node upon progression of state.

### SUMMARY OF THE INVENTION

This invention uses an administrator proxy contract protocol to protect the identity of the network node that will build the next block for a distributed and decentralized blockchain system. The administrator proxy contract is an agreement between two network nodes: if one party is selected by the blockchain state function as the administrator for the next block, the other party will act as the proxy of the selected administrator to perform the block building task. The identity of the selected administrator for the next block is publicly known since it is determined by the blockchain state function at the current blockchain state, the identity of the administrator proxy that will actually build the next block is kept private between the contract parties until the next block is built and published to the blockchain network.

This invention introduces notion of blockchain clock and blockchain time and a method to construct a blockchain clock and to measure the blockchain time. The blockchain clock is used to replace the computer hardware or software system clock and system time. For a synchronous or partially synchronous blockchain network system, the blockchain clock provides a globally synchronized measurement for the blockchain network system state progression and is used to define rounds and steps for building the blocks for the blockchain.

During each round of the block building and synchronization process, each network node tries to make contact to another network node in random order to propose an administrator proxy contract agreement, after the contract is accepted by another network node, each party signs the contract and keeps the contract private. Each party publishes to the blockchain network only a part of the contract that contains its network id and signature on the contract as the bit commitment of the contract. When an administrator proxy contract is executed, the proxy builds the new block and publishes the administrator proxy contract in the block. All other network nodes receive the new block and verify the administrator proxy contract against bit commitments previously published by the administrator and the proxy to determine the validity of the block builder. In the case of the failure of the proxy in building a block, the administrator marks the administrator proxy contract unfulfilled and publishes it to the blockchain network. The next block builder will exam a published unfulfilled contract against the previously published contract bit commitment, remove the failed proxy from the blockchain network if the unfulfilled contract is validated.

This invention introduces and defines a secured form of the blockchain state function for the state function driven consensus protocol of the distributed decentralized blockchain network. The secured form of the blockchain state function takes three independent parameters created and published to the blockchain at three different times, following the state function driven consensus protocol and the administrator proxy protocol each of the parameters is created at the time when the other two have not been published to the blockchain. Such defined blockchain state function is used to against any attempts by an adversary to try to manipulate the blockchain state and the blockchain state function output.

### BRIEF DESCRIPTION OF THE DRAWINGS

FIG. 1 Blockchain data model with administrator proxy contract

FIG. 2 Process flow for reaching to an administrator proxy contract agreement in a blockchain network

FIG. 3 Process flow for creating an administrator proxy contract data and send it to an admin candidate for acceptance

FIG. 4 Process flow for accepting an administrator proxy contract

FIG. 5 Process flow for creating an administrator self-proxy contract

FIG. 6 Process flow for accepting an administrator proxy contract bit commitment

FIG. 7 Blockchain state function driven consensus protocol with administrator proxy contract

FIG. 8 Process flow for creating a new block with administrator proxy contract

FIG. 9 Process flow for checking failed administrator proxy contract execution

FIG. 10 Process flow for adding failed administrators and failed administrator proxies

FIG. 11 Process flow for receiving and synchronizing a block with administrator proxy contract

### DETAILED DESCRIPTION OF THE INVENTION

The present disclosure is demonstrated using a cryptocurrency blockchain system built on an account-based transaction ledger, maintained by an open, decentralized peer-to-peer network of computer nodes.

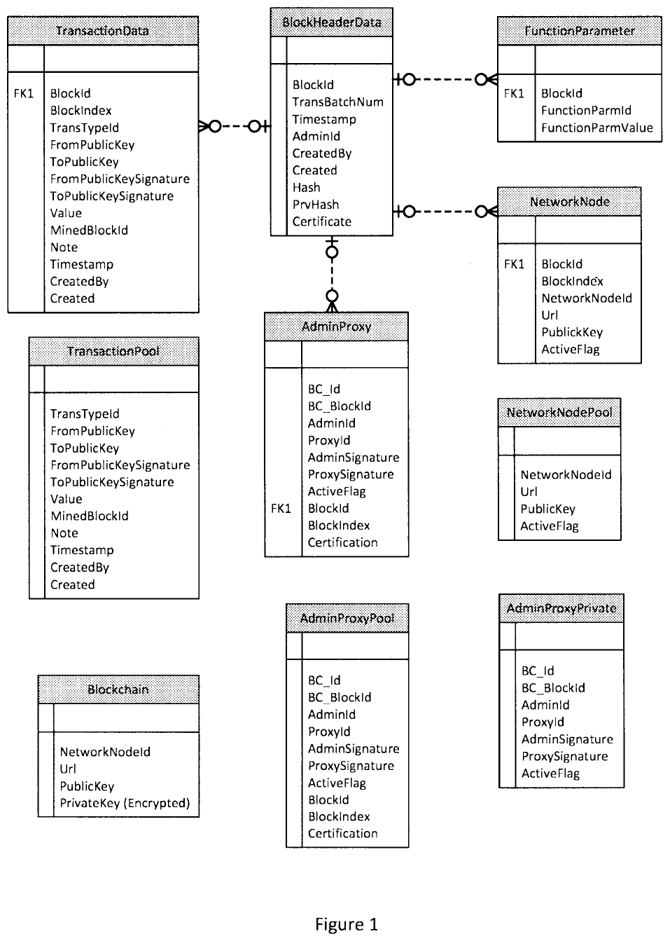

FIG. 1 shows the data model of the blockchain system. The data model consists of the following entities:
1. BlockHeaderData
   BlockHeaderData entity contains header information of each block in the blockchain.
2. TransactionData
   TransactionData entity contains all transaction entries that have been built into the blockchain, with a block id as the foreign key to group transaction entries into blocks. Within each block, transaction entries are ordered by the block index.
3. NetworkNode
   NetworkNode entity contains records of network nodes registered in the blockchain, with a block id as the foreign key to mark at which block when the network node is registered to the system, or at which block when the network node is removed from the system as a failed administrator or a failed proxy.
4. FunctionParameter
   FunctionParameter entity contains data used for blockchain and blockchain state function., with a block id as the foreign key to indicates which block the function parameters are applied for.
5. TransactionPool
   TransactionPool entity contains all transaction entries that have been received by the system but not yet built into the blockchain.
6. NetworkNodePool
   NetworkNodePool entity contains all the newly joined network nodes that have not yet been registered in the blockchain.
7. AdminProxy
   AdminProxy entity contains administrator proxy contract bit commitments and fulfilled or unfulfilled administrator proxy contracts that are published and built into the blockchain.
8. AdminProxyPool entity contains administrator proxy contract bit commitments and fulfilled or unfulfilled administrator proxy contracts that have been received by the system but not yet been built into the blockchain.
9. AdminProxyPrivate entity contains administrator proxy contracts between local network node and other network nodes.
10. Blockchain
   Blockchain entity contains a single record for the local network node. Each network node has an associated cryptocurrency wallet with a private and public key pair. When a network node is selected as administrator to build a block, the associated wallet's private key is used to sign the block hash as the block building certificate. After a network node is selected as an administrator and successfully builds a block, administration fee will be sent the wallet public key, by the next administrator selected to build the next block.

An administrator proxy contract (APC) consists of the following attributes
BC_Id: contract id;
BC_BlockId: blockchain time (block id) when the contract is created;
AdminId: administrator network node id;
ProxyId: proxy network node id;
AdminSignature: signature of the administrator on the contract;
ProxySignature: signature of the proxy on the contract;
ActiveFlag: Y=active, N=Inactive for private contract, Y=fulfilled, N=Unfulfilled for published contract;
BlockId: blockchain time (block id) when the contract is published to the blockchain;
BlockIndex: sequence number when the contract is published to the blockchain;
Certificate: signature of the publisher of contract;

An administrator self-proxy contract (ASPC) is a special APC on which both administrator and proxy are the same network node.

An administrator proxy contract bit commitment by administrator (APBCA) consists of the following attributes
BC_BlockId: blockchain time (block id) when the contract is created;
AdminId: administrator network node id;
AdminSignature: signature of the administrator on the contract;
ActiveFlag: Y=active, N=Inactive for private contract,
Certificate: signature of the publisher of contract bit commitment by administrator;

An administrator proxy contract bit commitment by proxy (APBCP) consists of the following attributes
BC_BlockId: blockchain time (block id) when the contract is created;
ProxyId: proxy network node id;
ProxySignature: signature of the proxy on the contract;
ActiveFlag: Y=active, N=Inactive for private contract,
Certificate: signature of the publisher of contract bit commitment by proxy;

An administrator self-proxy contract bit commitment (ASPBC) consists of the following attributes
BC_BlockId: blockchain time (block id) when the contract is created;
AdminId: administrator network node id;
AdminSignature: signature of the administrator on the contract;
ProxyId: administrator network node id;
ProxySignature: signature of the administrator on the contract;
ActiveFlag: Y=active, N=Inactive for private contract,
Certificate: signature of the publisher of contract bit commitment by administrator;

An administrator candidate pool (ACP) at blockchain state n is a subset of Active Registered Network Nodes (ARNN) that contains two groups of network nodes
1) All ARNN that has built successfully at least one block since it last joints the network;
2) First p members of all ARNN that has not yet built any blocks up to blockchain state n−1, order by block id and block index, where p is a pre-defined parameter.

ACP={n₀, n₁, n₂, . . . , n_{N-1}} (1)

where N is the total number of members in ACP.

The collection of indices of the administrator candidate pool is a set of whole numbers that identifies any specific node in ACP

IN={0, 1, 2, . . . , N−1} (2)

Live Network Nodes (LNN) are defined as a union of ARNN and newly joined network nodes in NetworkNodePool entity.

For a decentralized blockchain network system, there does not exist a global system clock that can be accessed by all the network nodes, nor a way to synchronize each of the local hardware or software system clocks of all the network nodes. To better describe the progression of the state of a blockchain network, notions of blockchain clock and blockchain time are introduced below.

A blockchain clock is a progression measurement device constructed based on the sequence of transactional activity events on a local copy of the blockchain and its transaction pool.

A blockchain time T is the measurement and reading of a blockchain clock, which consists of two numbers, T=(n, b), where n is the block number and b is the transaction batch number which is a scaled-up measure of the size of the blockchain transaction pool.

For a synchronous or partially synchronous blockchain network system where there exist upper bounds of message delivery time Δ and processing time discrepancy ϕ among all network nodes, if the transaction batch number b is defined such that the minimum time δᵢ required to fill up any transaction batch of size Sᵢ is much greater (by several orders of magnitude) than the above upper bounds, i.e., min (δᵢ)>>max (Δ, Φ), the blockchain clock time T from each of all network nodes is globally synchronized. For example, if it takes a maximum of 10⁻¹ sec. to process and synchronize any of the messages (e.g., a transaction or a block of transactions) among all network nodes, the size of a transaction batch can be chosen such that it takes at least 10² sec. to fill up a batch in a transaction pool in order to construct a globally synchronized blockchain clock. The blockchain time T=(n, b) is used to define the rounds and steps of the block building process.

At the beginning of each round of block building when T=(n, 0), each network node from the administrator candidate pool tries to reach an administrator proxy contract agreement with one another. Each round an administrator candidate can only have one network node as its proxy, and each network node can only be a proxy for one administrator candidate. After the administrator proxy contract is established, each party saves the contract locally and publishes the contract bit commitment to the blockchain.

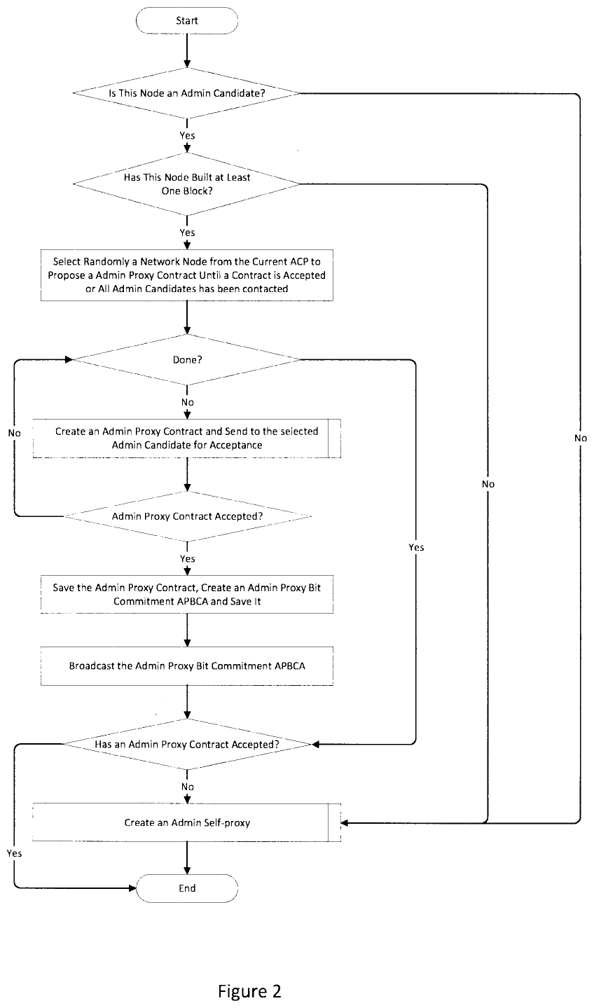

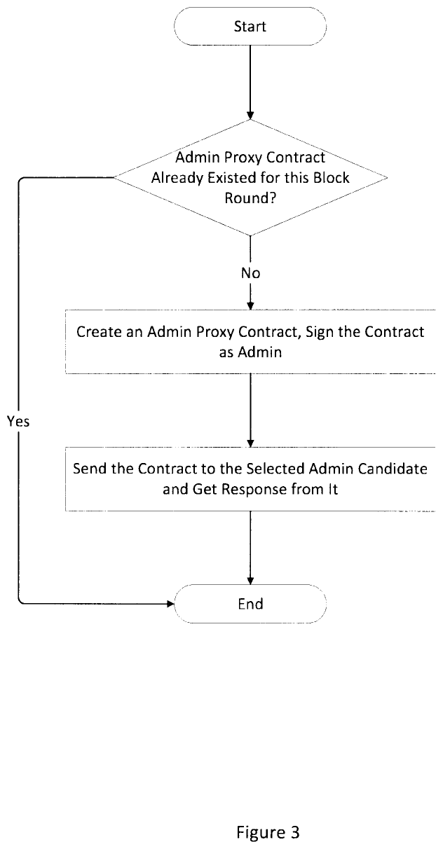

FIG. 2 shows the process flow for each network node executes to establish an administrator proxy contract. The process is executed in the following steps each time after a new block is added to the local copy of the network node:
1. The network node checks if it belongs to ACP, if it does, continues to the next step, otherwise, creates ASPC and exits;
2. the network node checks if it has built successfully at least one block since the last time it joins the blockchain network, if it does, continues to the next step, otherwise, creates ASPC and exits;
3. the network node selects each of the other network nodes from ACP, creates and proposes an APC to the selected network node (details shown in FIG. 3), continues the process until a proposed ACP is accepted by another network node or all of the network nodes from ACP has been contacted;
4. if a proposed APC is accepted by another network node, the network node saves the accepted APC to the local AdminProxyPrivate table, creates and saves administrator bit commitment APBCA to the local AdminProxyPool table, and publishes the APBCA to the blockchain network by broadcasting it to all LNN;
5. if no APC is accepted, the network node creates ASPC, saves the ASPC to the local AdminProxyPool table, and publishes the ASPC to the blockchain network by broadcasting it to all LNN;.

FIG. 3 shows the process flow of a network node from the administrator candidate pool creating and proposing an APC to another network node, the process is executed in the following steps:
1. The network node checks if an APC has already created for the current blockchain time, if it has not, continues to the next step, otherwise exits;
2. the network node creates an APC, signs it as administrator, proposes the APC to another network node by posting the APC to the other network node, waits for the response from the other network node;
3. the network node receives the response from the other network node and exits.

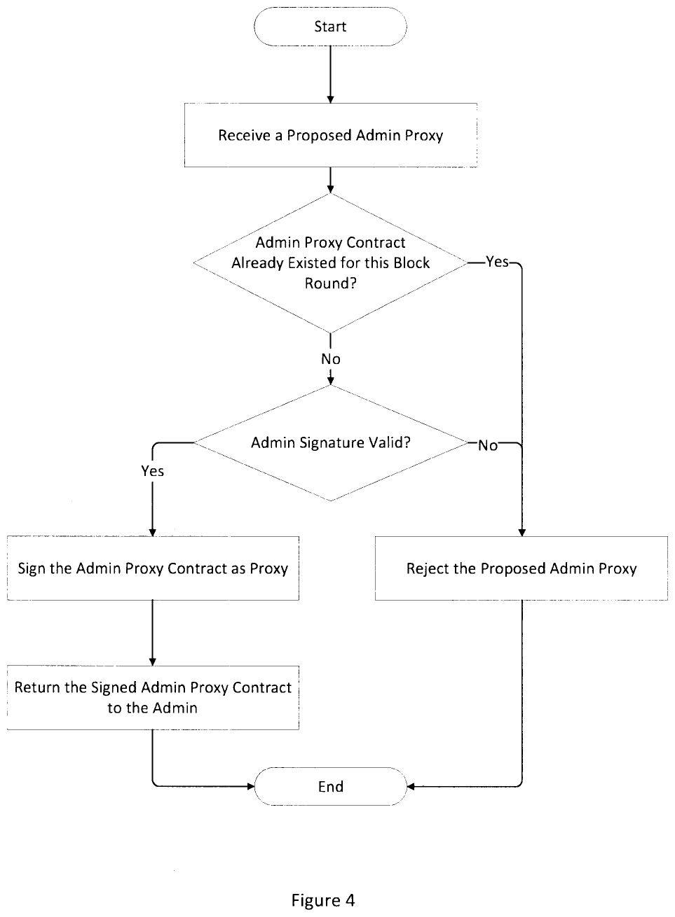

FIG. 4 shows the process flow of a network node from the administrator candidate pool receiving and accepting a proposed APC from another one:
1. The network node receives a proposed admin proxy contract;
2. the network node checks if an APC has already created for the current blockchain time, if it has not, continues to the next step, otherwise rejects the proposed by returning a null APC;
3. the network node validates the administrator signature of the proposed APC, if it is validated, continues to the next step, otherwise rejects the proposed by returning a null APC;
4. the network node signs the proposed APC as proxy, and returns the signed APC back to the proposing administrator network node.

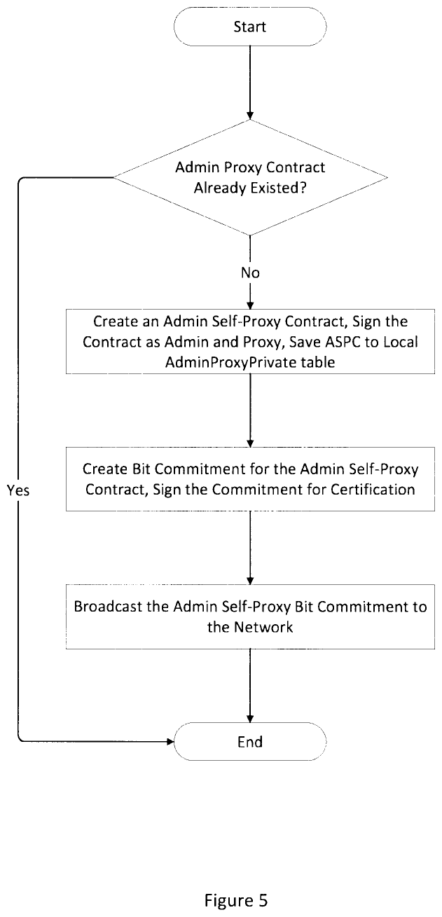

FIG. 5 shows the process flow of a network node from the administrator candidate pool creating an administrator self-proxy contract (ASPC), the process is executed in the following steps:
1. The network node checks if an APC has already created for the current blockchain time, if it has not, continues to the next step, otherwise exits;
2. the network node creates an ASPC, signs ASPC as administrator and as proxy, saves ASPC to local AdminProxyPrivate table;
3. the network node creates ASPBC, signs ASPBC for certificate, saves ASPBC to local AdminProxyPool table;
4. the network node publishes the ASPBC to the blockchain network by broadcasting it to LNN.

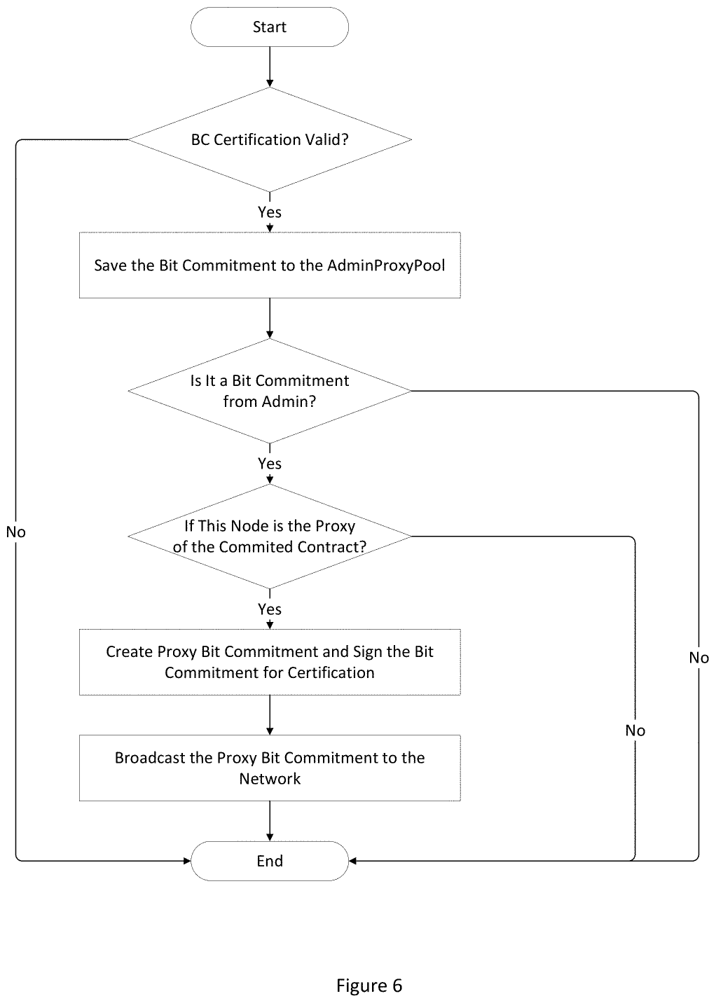

FIG. 6 shows the process flow for a network node from the administrator candidate pool to accept an administrator proxy contract bit commitment (APBCA or APBCP), the process is executed in the following steps:
1. The network node receives an administrator proxy contract bit commitment (APBCA or APBCP) and validates the certificate of it, if the certificate is validated, continues to the next step, otherwise exits;
2. the network node saves the administrator proxy contract bit commitment to local AdminProxyPool table;
3. the network node checks if the administrator proxy contract bit commitment is an APBCA, if it is, continues to the next step, otherwise exits;
4. the network node checks if it is the proxy of the received APBCA, if it is, continues to the next step, otherwise exits;
5. the network node creates a corresponding APBCP to the received APBCA, saves it to the local AdminProxyPool table;
6. the network node publishes the APBCP to the blockchain network by broadcasting it to all LNN.

A secured blockchain state function is defined as a unique and surjective mapping between the blockchain state and active registered network nodes

f(T)=f(n, b)=f(Eₙ₋₂, APCₙ₋₁, APCₙ, b) b>0, f ∈ IN (3)

where Eₙ₋₂ is a function of all block hashes (H₁, H₂, . . . , Hₙ₋₂) up to the block n−2, i.e., Eₙ₋₂=h(H₁, H₂, . . . , Hₙ₋₂), APCₙ₋₁, APCₙ are the administrator proxy contracts (or administrator self-contracts) presented by the builders of the blocks at n and n−1, and b is the transaction batch number.

The three independent parameters Eₙ₋₂, APCₙ₋₁, and APCₙ are created and published at different times as shown below, following the state function driven consensus protocol and the administrator proxy contract protocol. Each parameter is created at a time when the other two have not been published to the blockchain as shown in the below table.

| Parameter | Created | Published |
|---|---|---|
| Eₙ₋₂ | n − 2 | n − 2 |
| APCₙ₋₁ | n − 4 | n − 1 |
| APCₙ | n − 3 | n |

The secured form of the blockchain state function defined in (3) is used to against any attempts by an adversary to try to manipulate the blockchain state and the blockchain state function output.

The specific function form for the cryptocurrency in this disclosure is chosen as

f(T)=f(n, b)=SA(H(Eₙ₋₂|H(APCₙ₋₁)|H(APCₙ)|b)) mod L, b>0, f ∈ IN (4)

where Eₙ is a function of all block hashes at n, H is the SHA-256 hash function, the vertical bar | denotes string concatenation, b is the transaction batch number, L is the size of the administrator candidate pool (ACP). An Ascii summation function SA is defined as

SA=Σᵢ₌₀^{K-1}p(i)ASCII(Sᵢ) (5)

where K is the length of the string and Sᵢ is the character at position i of the string, ASCII(s) is the ascii function, and

$$p ( i ) = \{ \begin{matrix}{10}^{n - i + 1} , & i \leq n + 1 \\ 1 , & otherwise\end{matrix}$$

The secured blockchain state function from equation (4) is used for blocks with n>4; while for the initial 4 rounds of blocks the normal blockchain state function is used: f=f(n, b)=SA(H(Hₙ|b))mod L.

A block builder is either the administrator selected by the blockchain state function that does not have a committed administrator proxy contract or has a committed administrator self-proxy contract, or the proxy of the administrator selected.

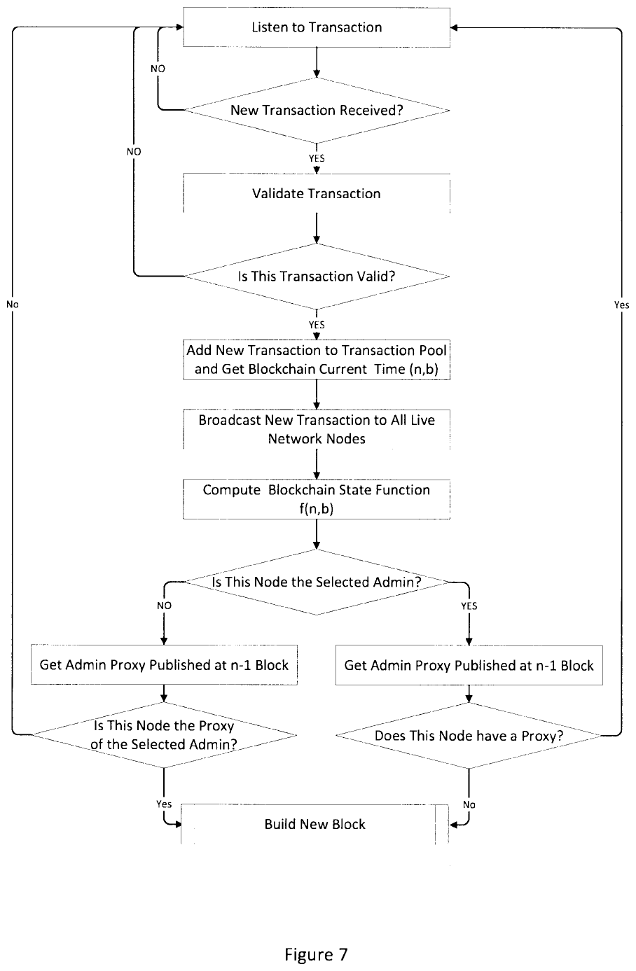

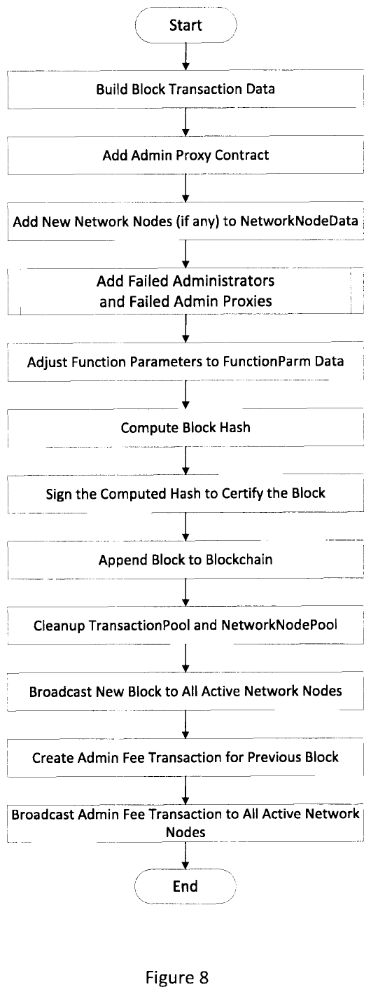

FIG. 7 shows the process flow of the state function driven consensus protocol with administrator proxy to select the block builder. Each network node from the administrator candidate pool executes the following steps:
1. Each network node has a service end point to listen and receive transaction entries, the transaction entries can be either posted directly from network users, or broadcasted from other network nodes;
2. after a transaction entry is received, it is validated against transactions in the blockchain and in the transaction pool. If the transaction is valid, it is added to the TransactionPool entity;
3. if a new transaction is added to the TransactionPool, current blockchain time T=(n, b) is read from the blockchain clock and the transaction is broadcasted to all LNN;
4. the blockchain state function in equation (4) is computed to find the selected administrator for building the next block;
5. if the result from the calculated blockchain state function indicates the selected administrator is the local network node itself, check the administrator proxy contracts built in the previous block (n−1), if no administrator proxy contract found for this network node, perform the task to build a new block (detailed steps for building a block described in FIG. 8);
6. if the result from the calculated blockchain state function indicates the selected administrator is not the local network node, check the administrator proxy contracts built in the previous block (n−1), if an administrator proxy contract found that the local network node is the proxy of the selected administrator, perform the task to build a new block (detailed steps for building a block described in FIG. 8).

Failed Administrator (FA) is defined as an administrator selected by the blockchain state function but does not perform its duty, this can be caused by the network node being offline, at fault, or any other process or network failures. If a block is being built at time T=(n, b), b>1, it indicates that there are failed administrator(s) at earlier time. The FA(s) can be identified by computing the blockchain state function for all transaction batch number(s) from 1 to b−1

f(n, bᵢ)=SA(H(Eₙ₋₂|H(APCₙ₋₁)|H(APCₙ)|bᵢ))mod L, i,bᵢ ∈ {1, . . . , b−1}, fᵢ ∈ IN (6)

A block builder first uses equation (6) to find all FA(s), for each FA found, if the FA does not have a committed administrator proxy contract or it has a committed administrator self-proxy contract, the block builder removes the FA from the blockchain. If the FA does have a committed administrator proxy contract, the block builder does not remove the FA since the failure is caused by the proxy whose identity is unpublished at the time.

A failed proxy's identity will be published by the administrator from the administrator proxy contract. After a new block is added to the blockchain, each network node checks if it is a FA using equation (6) due to the failure of its proxy. If failure of the proxy is found, the network node publishes the administrator proxy contract as unfulfilled to the blockchain to reveal the identity of the failed proxy, the failed proxy will be removed from the blockchain in a later round of block build process.

A block builder validates each published unfulfilled administrator proxy contract against commitments (APBCA and APBCP) published earlier, if the unfulfilled administrator proxy contract is validated and the administrator is a FA for a block built earlier, the block builder removes the failed proxy from the blockchain.

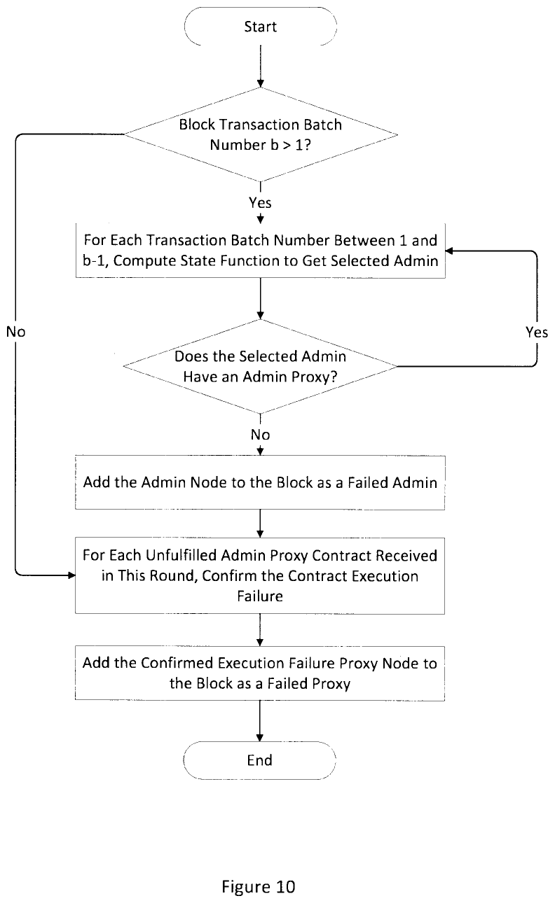

FIG. 8 show the detailed steps to build a block:
1. Move S number of transaction entries from TransactionPool entity to TransactionData entity. The number S is the transaction pool size when the blockchain state function is calculated to select the administrator (step 4 from FIG. 7). The transaction entries are marked with a new block id equal to the block id of the last block in the blockchain plus 1, the transaction entries are ordered by the local timestamp when they are received, and each of the transaction entries is assigned a block index ranging from number 1 to S according to their order;
2. add APC to the block if the builder is a proxy for an administrator, add ASPC to the block if the builder is the administrator itself;
3. if there are newly joined or removed network nodes in NetworkNodePool entity, move all the entries from the NetworkNodePool entity to NetworkNode entity, each new network node is marked with the new block id from step 1, and the new network nodes are ordered by the local timestamp when they are joined, and each of the new network nodes is assigned a block index ranging from number 1 to L where L is the NetworkNodePool size according to their orderings;
4. add failed administrators and failed administrator proxies to the block (detailed steps shown in FIG. 10);
5. take all the entries from FunctionParameter entity with previous block id, adjust the parameters if necessary, create entries with block id from step 1;
6. compute block hash and add the hash to the block header record with the previous block hash;
7. use the associate wallet's private key to sign the block hash and add the signature to the block header record as the block certification;
8. append the block the local copy of the blockchain;
9. cleanup TransactionPool and NetworkNodePool to remove records that has been built into the block;
10. broadcast the new block to all LNN;
11. if the previous block is built by an administrator proxy, create transaction entries to pay administration fee with pre-defined split percentage to the administrator and the proxy; if the previous block is built by the administrator itself, create a transaction entry to pay administration fee to the administrator;
12. broadcast the administration fee transaction entries to all LNN.

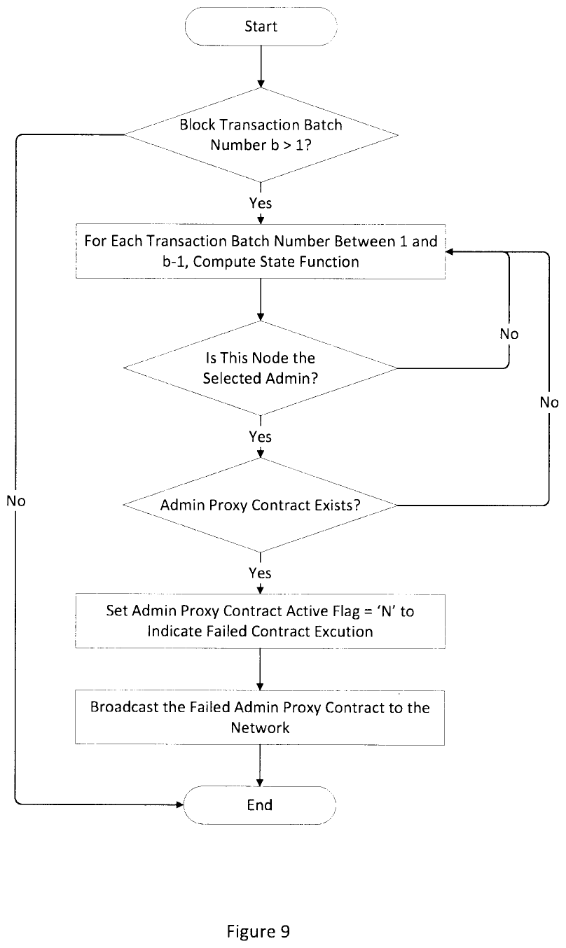

Each network node from the administrator candidate pool checks failed proxies after it receives and synchronize a new block. The detailed steps for checking failed proxies are shown in FIG. 9:
1. Check if the block was built at a time when transaction batch number b is greater than 1, if it is, continue to the next step, otherwise exit;
2. for each of the transaction batch number bᵢ between number 1 and b−1, compute the blockchain state function f(n, bᵢ) to determine the administrator for the block at the corresponding time;
3. check if the administrator from step 2 is the local network node, if it is, continue to the next step, otherwise go back to step 2 to evaluate the next transaction batch number;
4. check if an administrator proxy contract (APC) exists from block n−2, if it exists, mark the APC as unfulfilled by set its ActiveFlag=‘N’;
5. publish the unfulfilled APC to the blockchain network by broadcasting it to all LNN.

FIG. 10 shows the detailed steps for adding both failed administrators and failed proxies to a block:
1. Check if the transaction batch number b of the new block is greater than 1, if it is, continue to the next step, otherwise exit;
2. for each of the transaction batch number bᵢ between number 1 and b−1, compute the blockchain state function f(n, bᵢ) of equation (6) to determine the administrator for the block at the time;
3. check if an administrator proxy contract bit commitment (APBCA) by this administrator exists from block n−2, if it does not exist, add this administrator as failed administrator to the block;
4. go back to step 2 to evaluate the next transaction batch number;
5. for each unfulfilled APC received in AdminProxyPool, validate if the execution failed, if validated, add the proxy to as failed proxy to the block.

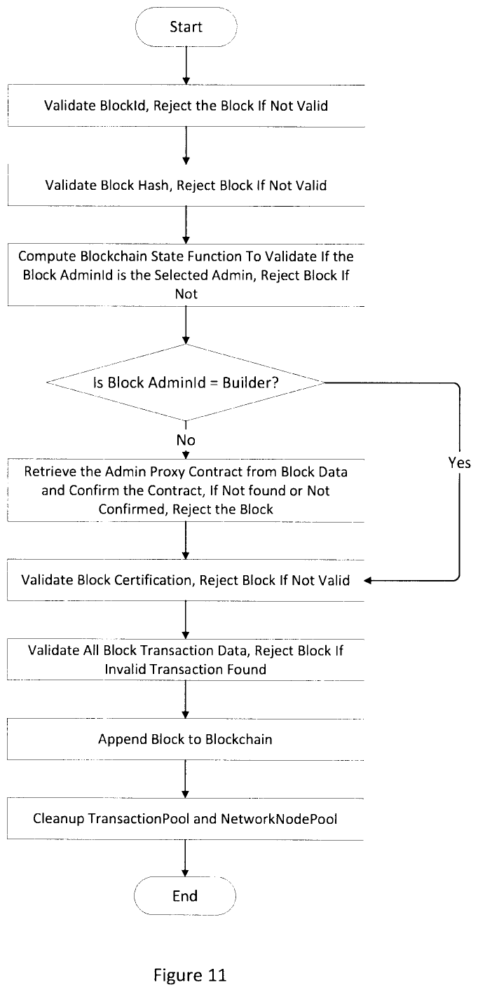

Each LNN has a service end point to receive a new block built and broadcasted by a selected administrator. FIG. 11 show the detailed steps a LNN to process a received new block.
1. Validate block id, the block id must be equal to the block id plus 1 from the last block of the local copy of the blockchain. If the block id is invalid, reject the block;
2. validate the previous hash value of the block is equal to the hash value of the last block of the local copy of the blockchain. If it is invalid, reject the block;
3. compute the block hash using the block data, validate the computed hash is equal to the hash value of the block. If it is invalid, reject the block;
4. compute the blockchain state function of equation (4) to validate the block adminId is the selected administrator's network id determined by the blockchain state function. If it is invalid, reject the block;
5. if the block adminId is not the same as the block builder id, retrieve the APC from the block data and validate the APC, if APC is not found in the block data or it is invalid, reject the block;
6. use the block builder's public key to validate the block's certificate, if it is invalid, reject the block;
7. validate all the transaction entries in the block, if any of the entries are found invalid, reject the block;
8. if all the validations from the above steps have passed, append the received block to the local copy of the blockchain;
9. cleanup TransactionPool and NetworkNodePool to remove the records that have been built into the block.

What is claimed is:

1. A peer-to-peer network system with a data model comprising of the followings:
a. BlockHeaderData which contains header information of each block in the blockchain;
b. TransactionData which contains all transaction entries on the accounting ledger, with a block id as the foreign key to group transaction entries into blocks, transaction entries are ordered by the block index;
c. NetworkNode which contains records of network nodes joined to the decentralized peer-to-peer network and registered in the blockchain, with a block id as the foreign key to mark at which block when the network node is registered to the system, and at which block when the network node is removed from the system if the network node is a failed administrator or a failed proxy;
d. FunctionParameter which contains data used for blockchain and blockchain state function., with a block id as the foreign key to indicates which block the function parameters are applied for;
e. TransactionPool which contains all transaction entries that have been received by the system but not yet built into the blockchain;
f. NetworkNodePool which contains all the newly joined or removed network nodes that have not yet been registered in the blockchain;
g. AdminProxy which contains administrator proxy contracts and administrator proxy contract bit commitments that are published and built into the blockchain;
h. AdminProxyPool which contains administrator proxy contracts and administrator proxy contract bit commitments that have been received by the system but not yet built into the blockchain;
i. AdminProxyPrivate which contains administrator proxy contracts between the system and other network nodes;
j. Blockchain which contains a single record for the local network node and its associated wallet public and private key pair.

2. A system as in claim 1, wherein a method to construct a blockchain clock and to measure blockchain time, comprising of the following steps:
a. a blockchain clock is built based on the sequential transactional activity events on blockchain and its transaction pool;
b. a blockchain time is measured by two numbers, T=(n, b), where n is the block number and b is the transaction batch number which is a scaled-up measure of the size of the blockchain transaction pool;
c. the transaction batch number b is defined such that the minimum time δᵢ required to fill up any transaction batch of size Sᵢ is much greater (by several orders of magnitude) than the above upper bounds, i.e., min (δᵢ)>>max(Δ, Φ), where Δ, ϕ are the upper bounds of message delivery time and processing time discrepancy among all network nodes.

3. A system as in claim 1 with the method of claim 2, wherein a process for each network node from the administrator candidate pool to reach administrator proxy contract agreement with another one, comprising of the following steps:
a. the network node checks if it belongs to ACP, if it does, continues to the next step, otherwise, creates ASPC and exits;
b. the network node checks if it builds successfully at least one block since the last time it joins the blockchain network, if it does, continues to the next step, otherwise, creates ASPC and exits;
c. the network node selects each of the other network nodes from ACP, creates and proposes an APC to the selected network node, continues the process until a proposed ACP is accepted by another network node or all of the network nodes from ACP has been contacted;
d. if a proposed APC is accepted by another network node, the network node saves the accepted APC to local AdminProxyPrivate table, creates and saves administrator bit commitment APBCA to local AdminProxyPool table, and publishes the APBCA to the blockchain network by broadcasting APBCA to all LNN;
e. if no APC is accepted, the network node creates ASPC.

4. The process of claim 3, wherein a subprocess for a network node from the administrator candidate pool to create and to propose an APC to another network node, comprising of the following steps:
a. check if an APC has already been created for the current blockchain time, if it has not, continue to the next step, otherwise exit;
b. create an APC, sign it as administrator, proposes the APC to another network node by posting the APC to the other network node, wait for the response from the other network node;
c. receive the response from the other network node and exit.

5. A system as in claim 1 with the method of claim 2 and the process of claim 3, wherein a process of a network node from the administrator candidate pool to receive and to accept a proposed APC from another one, comprising the following steps:
a. the network node checks if an APC has already been created for the current blockchain time, if it has not, continues to the next step, otherwise rejects the proposed by returning a null APC;
b. the network node validates the administrator signature of the proposed APC, if it is validated, continues to the next step, otherwise rejects the proposed by returning a null APC;
c. the network node signs the proposed APC as proxy, and returns the signed APC back to the proposing administrator.

6. The process of claim 3, wherein a subprocess for a network node from the administrator candidate pool to create an administrator self-proxy contract (ASPC), comprising of the following steps:
a. the network node checks if an APC has already been created for the current blockchain time, if it has not, continues to the next step, otherwise exits;
b. the network node creates an ASPC, signs ASPC as administrator and proxy, saves ASPC to local AdminProxyPrivate table;
c. the network node creates ASPBC, signs ASPBC for certificate, saves ASPBC to local AdminProxyPool table;
d. the network node publishes the ASPBC to the blockchain network by broadcasting it to the blockchain network.

7. A system as in claim 1 with the method of claim 2, the processes of claim 3 and claim 5, wherein a process for a network node from the administrator candidate pool to accept an administrator proxy contract bit commitment (APBCA or APBCP), comprising of the following steps:
a. the network node validates the certificate, if it is validated, continues to the next step, otherwise exits;
b. the network node saves the administrator proxy contract bit commitment to local AdminProxyPool table;
c. the network node checks if the administrator proxy contract bit commitment is an APBCA, if it is, continues to the next step, otherwise exits;
d. the network node checks if it is the proxy of the received APBCA, if it is, continues to the next step, otherwise exits;
e. the network node creates a corresponding APBCP to the received APBCA, saves it to the local AdminProxyPool table;
f. the network node publishes the APBCP to the blockchain network by broadcasting it to the blockchain network.

8. A system as in claim 1 with the method of claim 2, the processes of claim 3, claim 5, and claim 7, wherein a method to compute a secured form of blockchain state function value to select an administrator using a formula defined as a unique and surjective mapping between the blockchain state and administrator candidate pool based on a blockchain state with four parameters:
a. a function of all block hashes the blockchain calculated at two rounds prior to the current block;
b. the APC or ASPC data of the builder of the previous block;
c. the APC or ASPC data of the builder of the current block;
d. the transaction batch number of the current blockchain time.

9. A system as in claim 1 with the methods of claim 2 and claim 8, the processes of claim 3, claim 5, claim 7, wherein a process of a state function driven consensus protocol with administrator proxy contract executed by each network node from the administrator candidate pool, comprising of the following steps:
a. each network node has a service end point to listen and receive transaction entries, the transaction entries can be either posted directly from network users, or broadcasted from other network nodes;
b. after a transaction entry is received, it is validated against transactions in the blockchain and in the transaction pool, if the transaction is valid, it is added to the TransactionPool entity;
c. if a new transaction is added to the TransactionPool, it is broadcasted to the blockchain network;
d. compute the blockchain state function value to find the selected administrator for building the next block;
e. if the result from the calculated blockchain state function indicates the selected administrator is the local network node itself, check the administrator proxy contracts built in the previous block, if no administrator proxy contract found for this network node, it performs that task to build a next block;
f. if the result from the calculated blockchain state function indicates the selected administrator is not the local network node, check the administrator proxy contracts built in the previous block, if an administrator proxy contract found that the local network node is the proxy of the selected administrator, perform the task to build a new block.

10. The process of claim 9, wherein a subprocess for building a block comprising of the following steps:
a. move S number of transaction entries from the TransactionPool entity to the TransactionData entity, where the number S being the transaction pool size when the blockchain state function being calculated to select the administrator, the transaction entries being marked with a new block id equal to the block id of the last block in the blockchain plus 1, the transaction entries being ordered by the local timestamp when their being received, and each of the transaction entries being assigned a block index ranging from number 1 to S according to their orderings;
b. add APC to the block if the builder is a proxy for an administrator, add ASPC to the block if the builder is the administrator;
c. if there are newly joined or removed network nodes in NetworkNodePool entity, move all the entries from the NetworkNodePool entity to NetworkNode entity, each new network node is marked with the new block id, and the new network nodes are ordered by the local timestamp when they are joined, and each of the new network nodes is assigned a block index ranging from number 1 to L where L is the NetworkNodePool size according to their orderings;
d. take all the entries from FunctionParameter entity with previous block id, adjust the parameters if necessary;
e. compute block hash and add the hash to the block header record with the previous block hash;
f. use the associate wallet's private key to sign the block hash and add the signature to the block header record as the block building certification;
g. append the block the local copy of the blockchain;
h. cleanup TranasctionPool and NetworkNodePool to remove records that have been built into the block;
i. broadcast the new block to all live network nodes;
j. if the previous block is built by an administrator proxy, create transaction entries to pay administration fee with pre-defined split percentage to the administrator and the proxy; if the previous block is built by the administrator itself, create a transaction entry to pay administration fee to the administrator;
k. broadcast the administration fee transaction entries to all live network nodes.

11. A system as in claim 1 with the methods of claim 2 and claim 8, the processes of claim 3, claim 5, claim 7, and claim 9, wherein a process for each network node from the administrator candidate pool to check failed proxies, being executed after receiving and synchronizing a new block, comprising of the following steps:
a. check if the transaction batch number b of the new block is greater than 1, if it is, continue to the next step, otherwise exit;
b. for each of the transaction batch number bᵢ between number 1 and b−1, compute the blockchain state function to determine the administrator for the block;
c. check if the administrator from step b is the local network node, if it is, continue to the next step, otherwise go back to step b to evaluate the next transaction batch number;
d. check if an administrator proxy contract (APC) exists from the block two round prior, if it exists, mark the APC as unfulfilled;
e. broadcast the unfulfilled APC to the blockchain network.

12. A system as in claim 1 with the methods of claim 2 and claim 8, the processes of claim 3, claim 5, claim 7, and claim 9, wherein a process to add failed administrators and failed proxies to the block, comprising of the following steps:
a. check if the transaction batch number b of the new block is greater than 1, if it is, continue to the next step, otherwise exit;
b. for each of the transaction batch number between number 1 and b−1, compute the blockchain state function to determine the administrator for the block;
c. check if an administrator proxy contract bit commitment (APBCA) by this administrator exists from the block two round prior, if it does not exist, add this administrator as failed administrator to the block;
d. for each unfulfilled APC received in AdminProxyPool, validate if the execution failed, if validated, add the proxy to as failed proxy to the block.

13. A system as in claim 1 with the methods of claim 2 and claim 8, the processes of claim 3, claim 5, claim 7, and claim 9, wherein a process for receiving a new block, comprising of the following steps:
a. validate block id, where the block id must be equal to the block id plus 1 from the last block of the local copy of the blockchain, If the block id is invalid, reject the block;
b. validate the previous hash value of the block is equal to the hash value of the last block of the local copy of the blockchain, if it is invalid, reject the block;
c. compute the block hash using the block data, validate the computed hash is equal to the hash value of the block, if it is invalid, reject the block;
d. compute the blockchain state function to validate the block adminId being the selected administrator's network id determined by the blockchain state function, if it is invalid, reject the block;
e. if the block adminId is not the same as the block builder id, retrieve the APC from the block data and validate the APC, if APC is not found in the block data or it is invalid, reject the block;
f. use the public key of the block creator to validate the block's certificate, if it is invalid, reject the block;
g. validate all the transaction entries in the block, if any of the entries are found invalid, reject the block;
h. if all the validations from the above steps are passed, append the received block to the local copy of the blockchain;
i. cleanup TranasctionPool and NetworkNodePool to remove records that have been built into the block.
